(19) United States
(12) Patent Application Publication
(10) Pub. No.: US 2019/0048120 A1
(43) Pub. Date: Feb. 14, 2019

(54) RESORCINOL RESINS AND COMPOSITIONS DERIVED THEREFORM

(71) Applicants: SUMITOMO BAKELITE EUROPE N. V., GENK (BE); SUMITOMO BAKELITE NORTH AMERICA, INC., NOVI, MI (US)

(72) Inventors: WOUTER VANORMELINGEN, GENK (BE); TOM DE SMEDT, GENK (BE)

(73) Assignees: SUMITOMO BAKELITE EUROPE N. V., GENK (BE); SUMITOMO BAKELITE NORTH AMERICA, INC., NOVI, MI (US)

(21) Appl. No.: 16/100,407

(22) Filed: Aug. 10, 2018

Related U.S. Application Data
(60) Provisional application No. 62/544,344, filed on Aug. 11, 2017.
(60) Provisional application No. 62/635,730, filed on Feb. 27, 2018.

(51) Int. Cl. C08G 8/22; C08K 5/13; C08K 5/42; C08K 5/092; C08L 19/00; B01D 3/10; B01D 3/34

(52) U.S. Cl. CPC C08G 8/22; C08K 5/13; C08K 5/42; C08G 2380/00; C08L 19/00; B01D 3/10; B01D 3/34; C08K 5/092

(57) ABSTRACT

A process for the preparation of a novolac resorcinol resin is disclosed which includes a defined mixture of resorcinol, phenol, cashew nut shell liquid, an aldehyde, and an acid catalyst. More specifically, the resorcinol resin produced in accordance with the instant process contains less than 0.5 weight percent of resorcinol, 1.0 weight percent of phenol and less than 1.0 weight percent of cashew nut shell liquid components. The molar ratio of aldehyde in comparison to the combined resorcinol/phenol mixture is less than 1. The novolac resorcinol resins prepared according to this invention exhibit improved reinforcing properties, tackifying properties and adhesion properties, among others, and therefore are suitable in a variety of rubber applications. In addition, the instant process provides less fuming of the resorcinol thus offering improved safety and environmental advantages over the conventional methods for preparing similar resorcinol resins.

### CROSS REFERENCE TO RELATED APPLICATIONS

This application claims the benefit of U.S. Provisional Application No. 62/544,344, filed Aug. 11, 2017; and U.S. Provisional Application No. 62/635,730, filed Feb. 27, 2018; both of which are incorporated herein by reference in their entirety.

### BACKGROUND OF THE INVENTION

### Field of the Invention

The current invention relates to novolac resorcinol resins and a method of their making. More specifically, the invention describes a process for the production of resorcinol resins that contain low levels of free resorcinol, for example, below 0.1 to 0.5 weight percent based on the total amount of resorcinol resin produced. The present invention also relates to the use of these resorcinol resins as an adhesion promoter resin in various applications, such as for example, for the production of various rubbers and other compositions, more specifically resins for car tyres.

### Description of the Art

Resorcinol resins, particularly, resorcinol formaldehyde resins are extensively used as adhesives or adhesion promoters in, for example, the wood and rubber industry. However, resorcinol and novolac resorcinol resins, which contain a high content of free resorcinol, are hygroscopic and produce resorcinol fumes when heated. The fuming and hygroscopic nature of resorcinol (resins) poses problems in handling and use of these materials in a variety of applications including in the formulation of rubber compounds. Furthermore, the resorcinol fumes pose a health and environmental hazard and an economic loss of resorcinol. As such, a drop in the free resorcinol content of such resins allows easier processing and has a health, environmental and economic benefit.

Due to the nature of the resorcinol-formaldehyde polymerization, namely a step-growth polymerization, and the use of a molar excess of resorcinol, a certain percentage of unreacted resorcinol will remain present after the polymerization reaction is finished. The statistical model as developed by Borrajo et al. (Polymer, Vol. 23, p 263-266 (1982)) predicts for polycondensations of phenol and formaldehyde free phenol levels of 11.6, 6.5 and 3.0% for molar ratios of 0.7, 0.8 and 0.9 respectively. This statistical model shows that by increasing the molar ratio of formaldehyde/resorcinol, the free resorcinol content in the resin is reduced. That is, higher molar ratio of formaldehyde needs to be used. However, as generally known by those skilled in the art, this will also increase the molecular weight and softening point of the resin. A higher softening point requires a higher processing temperature (e.g. during industrial rubber tyre production), which is undesirable.

There has been considerable amount of work reported in the art addressing this issue. For example, U.S. Pat. No. 4,889,891 discloses that both the hygroscopic nature and the fuming of resorcinol resins are reduced by resorcinol alkyl-functionalization with an alkene under acidic catalysis prior to the polycondensation reaction with an aldehyde. Due to the hydrophobic nature of the alkylated resorcinol, the hydrophilicity of the resin is reduced. Also, the fuming during processing is reduced, since the alkylated resorcinol has a higher boiling point. Although this approach solves the hygroscopic nature of conventional resorcinol resins, the fuming issue is only partly resolved since there are still significant amounts of free (alkylresorcinol) monomers present.

U.S. Pat. No. 7,425,602 B2 describes the preparation of a low fuming novolac resin by copolymerization of alkylphenol(s), resorcinol and phenol with an aldehyde. However, this procedure requires, due to the reduced reactivity of para (or ortho in this respect)-alkylphenols with respect to formaldehyde, a two-step process, as apparent from the examples provided therein. That is, in the first step, a reaction between an alkylphenol, phenol and formaldehyde is carried out. And in the second step, resorcinol, phenol and additional formaldehyde are added.

CN 10391084 describes a process for making novolac resins from resorcinol and cashew nut shell liquid (CNSL). However, in this method there is a significant amount of free resorcinol present, for example, it is reported that the free resorcinol content in these resins can be as much as 5-18 weight percent. In addition, it is not clear as to the melt stability of such resins. Nevertheless, these resins do not satisfactorily solve the aforementioned problems associated with conventional resorcinol resins and might even add stability issues related to the alkene functionality of the CNSL components.

From the foregoing it is evident that there is no one-step process currently available for producing resorcinol resins which contain low levels of resorcinol, i.e., lower than 0.5 weight percent, and as a consequence low levels of fuming when further processed.

Accordingly, it is an object of this invention to provide a process for making resorcinol resins containing very low levels of free resorcinol. It is further an object of this invention to provide a process for making resorcinol resins where the fuming of resorcinol is alleviated thus solving safety and environmental issues. Finally, it is also an object of this invention to provide a process for forming resorcinol resins, which exhibit improved adhesion properties for a variety of industrial applications. The resorcinol resins thus formed by the process of this invention therefore find a number of applications where such resins with low levels of free resorcinol are desirable, including a number of rubber applications, for example car tyres.

### SUMMARY OF THE INVENTION

Surprisingly, it has now been found that by incorporation of certain amount of cashew nut shell liquid (CNSL) along with resorcinol and phenol the process as used herein produces novolac resins that satisfactorily solve the problems described related to conventional resorcinol resins. At the same time, the resins according to the present invention offer an equivalent or better level of performance to conventional resorcinol resins and thus provide hitherto unreachable advantages over the conventional methods. More specifically, the resorcinol resins produced in accordance of the process of this invention find better use in a variety of applications, including but not limited to rubbers or other compositions as adhesion promoters or reinforcing resins or tackifying resins or any other purpose to which these resins may be fit. More suitably these resins are used as adhesion promoters. Even more importantly, as further described herein, the resins of this invention exhibit much improved mixing properties with various components of a rubber formulation thus surprisingly requiring shorter mixing time than most conventional resins employed in similar applications.

As noted, the novolac resins according to the current invention contain resorcinol, phenol and CNSL. These resins have a low resorcinol, phenol and CNSL content in combination with a softening point desirable from the viewpoint of processing the resin in the final application. Typically, as is known by those skilled in the art, resins containing CNSL can have a reduced stability at high temperatures due to reaction of the alkene functionality of the CNSL components. These reactions gradually increase the softening point of the resins and eventually lead to jellification, which complicates the large-scale production of such resins. For example, pelletizing 15 metric tons of such resins can take up to 9 hours at temperatures during which the softening point significantly increases, potentially to the point where pelletizing becomes unfeasible. As is known by those skilled in the art, large batches of phenolic resins that show an increase of their softening point over time in their molten state, are typically dropped, either on the floor or on lamellae. This allows a fast cooling and solidification of the resins, which stabilizes the resin. However, the solid resin chunks need further processing such as pulverizing, which is economically less favorable than pelletizing.

Accordingly, in another aspect of this invention there is further provided a process to improve the stability at high temperature of resorcinol resins made with CNSL, to allow processing of the resin to pellets or flakes without a significant increase in the softening point.

### DETAILED DESCRIPTION

The terms as used herein have the following meanings:

As used herein, the articles “a,” “an,” and “the” include plural referents unless otherwise expressly and unequivocally limited to one referent.

Since all numbers, values and/or expressions referring to quantities of ingredients, reaction conditions, etc., used herein and in the claims appended hereto, are subject to the various uncertainties of measurement encountered in obtaining such values, unless otherwise indicated, all are to be understood as modified in all instances by the term “about.” Where a numerical range is disclosed herein such range is continuous, inclusive of both the minimum and maximum values of the range as well as every value between such minimum and maximum values. Still further, where a range refers to integers, every integer between the minimum and maximum values of such range is included. In addition, where multiple ranges are provided to describe a feature or characteristic, such ranges can be combined. That is to say that, unless otherwise indicated, all ranges disclosed herein are to be understood to encompass any and all sub-ranges subsumed therein. For example, a stated range of from “1 to 10” should be considered to include any and all sub-ranges between the minimum value of 1 and the maximum value of 10. Exemplary sub-ranges of the range 1 to 10 include, but are not limited to, 1 to 6.1, 3.5 to 7.8, and 5.5 to 10, etc.

As used herein, the expression “alkyl” means a saturated, straight-chain or branched-chain hydrocarbon substituent having the specified number of carbon atoms, including for example, methyl and ethyl groups, and straight-chained or branched propyl, butyl, pentyl, hexyl, heptyl, octyl, nonyl, decyl, undecyl, and the like groups. Particular alkyl groups, include without any limitation methyl, ethyl, n-propyl, isopropyl and tert-butyl, n-pentyl, and the like.

As used herein, the expression “aryl” means an aromatic mono- or polycyclic hydrocarbon substituent having the specified number of carbon atoms, which may include for example substituted or unsubstituted phenyl, naphthyl, anthracenyl and the like. Specific examples of substituted phenyl or naphthyl include o-, p-, m-tolyl, 1,2-, 1,3-, 1,4-xylyl, 1-methylnaphthyl, 2-methylnaphthyl, etc. “Substituted phenyl” or “substituted naphthyl” also include any of the possible substituents as further defined herein or one known in the art.

As used herein, the expression “(C₆-C₁₀)aryl(C₁-C₄)alkyl” means that the (C₆-C₁₀)aryl as defined herein is further attached to (C₁-C₄)alkyl as defined herein. Representative examples include benzyl, phenylethyl, 2-phenylpropyl, 1-naphthylmethyl, 2-naphthylmethyl and the like.

Accordingly, in accordance with the practice of this invention there is provided a process for the preparation of resorcinol resins, comprising:

(a) providing 5 to 45 weight percent, based on the total amount of a phenolic compound and a resorcinol compound mixture, of resorcinol compound of formula (I):

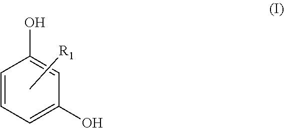

wherein R₁ is selected from the group consisting of hydrogen, linear or branched (C₁-C₁₈)alkyl, and (C₆-C₁₀)aryl(C₁-C₄)alkyl, and providing 55 to 95 weight percent, based on the total amount of phenol and resorcinol mixture, one or more of phenolic compound of formula (II);

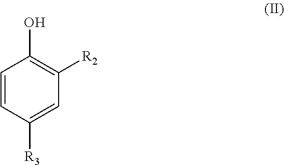

wherein R₂ and R₃ may be the same or different and each independently of each other selected from the group consisting of hydrogen, linear or branched (C₁-C₁₈)alkyl, and (C₆-C₁₀)aryl(C₁-C₄)alkyl;
(b) providing cashew nut shell liquid comprising one or more compounds of formula (IV):

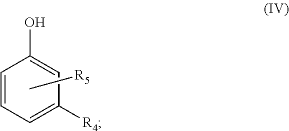

wherein R₄ is selected from the group consisting of n-C₁₅H₃₁alkyl, n-C₁₅H₂₉alkene, n-C₁₅H₂₇dialkene and n-Cl₅H₂₅trialkene; and R₅ is hydrogen, methyl or CO₂H;
(c) adding an acid; and
(d) adding an aldehyde of formula (III):

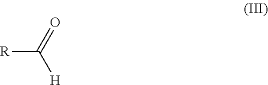

wherein R is selected from the group consisting of hydrogen and linear or branched (C₁-C₄)alkyl.

In one embodiment, the resorcinol resin produced in accordance of this invention contains less than 0.5 weight percent of each individual unreacted resorcinol of formula (I), based on the total weight of resorcinol resin.

In one embodiment, the resorcinol resin produced in accordance of this invention contains less than 0.1 weight percent of each individual unreacted resorcinol of formula (I), based on the total weight of resorcinol resin.

In one embodiment, the resorcinol resin produced in accordance of this invention contains less than 0.5 weight percent of each individual unreacted resorcinol of formula (I); contains less than 1 weight percent of each individual unreacted phenolic compound of formula (II); and contains less than 1 weight percent of unreacted cashew nut shell liquid, based on the total amount of resorcinol resin.

In one embodiment, the resorcinol resin produced in accordance of this invention contains less than 0.25 weight percent of each individual unreacted resorcinol of formula (I); contains less than 0.5 weight percent of each individual unreacted phenolic compound of formula (II); and contains less than 0.5 weight percent of unreacted cashew nut shell liquid, based on the total amount of resorcinol resin.

In one embodiment, the resorcinol resin produced in accordance of this invention contains less than 2 weight percent of total unreacted monomers, including unreacted resorcinol of formula (I); unreacted phenolic compound of formula (II); and unreacted cashew nut shell liquid, based on the total amount of resorcinol resin.

Surprisingly, it has now been found that it is advantageous to employ lower amounts of aldehyde when compared with the total amount of resorcinol compound of formula (I) and phenolic compound of formula (II), i.e., the total moles of phenolic components including compound of formulae (I) and (II). Accordingly, in one embodiment the molar ratio of aldehyde/total phenolic components, i.e., total moles of resorcinol compound of formula (I) and the phenolic compound of formula (II)) is in the range from 0.4 to 0.8. In another embodiment of the process according to this invention the molar ratio of the aldehyde of formula (III) to the total amount of the chemical substances of formula (I) and (II) is less than 1.

In one embodiment the process according to this invention there is employed molar ratio of the aldehyde of formula (III) to the total amount of the chemical substances of formula (I) and (II) is from 0.5 to 0.75.

In one embodiment the resorcinol compound of formula (I) used in the process of this invention is resorcinol.

In one embodiment the phenolic compound of formula (II) used in the process of this invention is selected from the group consisting of phenol, o-cresol, m-cresol, p-cresol, 2,3-xylenol, 2,4-xylenol, 2,5-xylenol, 2,6-xylenol, 3,4-xylenol and 3,5-xylenol, and mixtures in any combination thereof.

In one embodiment the aldehyde of formula (III) used in the process of this invention is selected from the group consisting of formaldehyde, acetaldehyde, propionaldehyde, n-butyraldehyde, iso-butyraldehyde, glyoxal and furfural.

It is known in the art that the cashew nut shell liquid comprises various compounds of formula (IV). Generally, naturally occurring CNSL is believed to contain at least four compounds of formulae (IVA) to (IVD). However, the amount of these four compounds can vary from batch to batch and can be chemically modified to one major component.

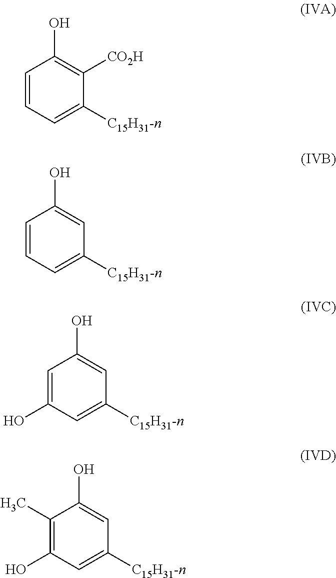

The structures (IVA) to (IVD) are shown with a moiety, C₁₅H₃₁-n, where n determines the level of unsaturation of the group. That is, when n=0, it is fully saturated. Otherwise, CNSL contains varied amounts of unsaturated alkenes, including monoene (n=2), diene (n=4) and triene (n=6) with the positions of double bonds as shown in formulae (IVE). All such CNSL compositions whether natural or synthetically modified can be employed in the process of this invention in order to produce the resorcinol resin as described herein.

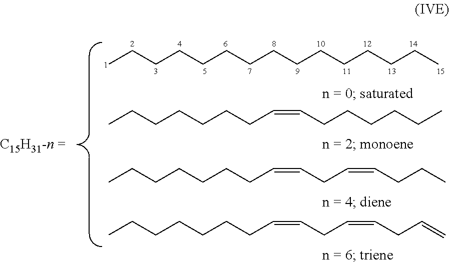

Generally, naturally occurring CNSL is believed to contain the compound of formula (IVA), which is known as anacardic acid at a level of 74 to 77%, the compound of formula (IVB), which is known as cardanol at a level of 1 to 9%, the compound of formula (IVC), which is known as cardol at a level of 15 to 20% and the compound of formula (IVD), which is known as 2-methyl cardol at a level of 2 to 3%. However, one of skill in the art readily knows that the compositions of CNSL can be readily modified. All such synthetically modified compositions of CNSL can be employed in the process of this invention. For instance, heat treatment of natural CNSL results in the decarboxylation of anacardic acid (i.e., a compound of formula IVA) to form cardanol (i.e., a compound of formula IVB). Accordingly, all such variants of CNSL can be employed in the process of this invention.

In one embodiment the resorcinol compound of formula (I) used in the process of this invention is resorcinol, phenolic compound of formula (II) is phenol, the cashew nut shell liquid is cardanol of formula (IVB) and the aldehyde of formula (III) is formaldehyde.

In one embodiment the acid used in the process of this invention is selected from the group consisting of sulfuric acid, sulfonic acids, and carboxylic acids, e.g., sulfuric acid, p-toluene sulfonic acid, methane sulfonic acid, dodecylbenzene sulfonic acid, triflic acid, fluorosulfuric acid and oxalic acid.

In one embodiment the acid used in the process of this invention is oxalic acid.

In one embodiment the aldehyde used in the process of this invention is formaldehyde, preferably used as an aqueous solution thereof.

In one embodiment the process according to this invention the aldehyde used is having the structural formula (III), which is obtained by adding chemical substances that can decompose into similar aldehydes, the chemical substances that can decompose being selected from the group consisting of paraformaldehyde, paraldehyde, trioxane, furfural, hexamethylenetetramine, (3-hydroxybutyraldehyde, acetals such as methylformcel and butylformcel, and mixtures of at least 2 of the same.

In one embodiment the process according to this invention water is removed, preferably at temperatures below 125° C. and more preferably below 115° C., from the reaction mixture by vacuum distillation.

In one embodiment the process according to this invention, the reaction mixture is neutralized at temperatures preferably below 125° C. and more preferably below 115° C.

In another aspect of this invention there is further provided a process according to this invention, which further comprises the following steps for processing the mixture after completion of a condensation reaction:

a step of distilling the mixture at atmospheric pressure until a temperature of about 120° C. to 145° C. is reached, without neutralizing the acid beforehand;

after that, a step of neutralizing the acid; and

after that, a step of carrying out a distillation under a reduced pressure of 100 mm Hg or less until a temperature of about 150° C. to 180° C. is reached.

In a further aspect of this invention there is further provided a novolac resorcinol resin obtained by the process according to this invention, wherein the novolac resorcinol resin exhibits a softening temperature of from 80 to 130° C., and more preferably 90 to 110° C., and less than 0.5 weight percent and preferably less than 0.1 weight percent of each resorcinol and less than 0.5 weight percent phenol and less than less than 0.5 weight percent cashew nut shell liquid, based on the total amount of novolac resorcinol resin.

In one embodiment there is also provided a novolac resorcinol resin obtained by the process according to this invention, wherein the cashew nut shell liquid is cardanol.

In a further aspect of this invention there is also provided a resorcinol resin, comprising the condensation product of:

a) 5 to 45 weight percent, based on the total amount of a phenolic compound and a resorcinol compound mixture, of resorcinol compound mixture of formula (I):

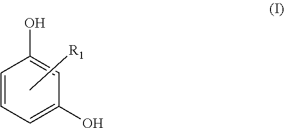

wherein R₁ is selected from the group consisting of hydrogen, linear or branched (C₁-C₁₈)alkyl, and (C₆-C₁₀)aryl(C₁-C₄)alkyl;
b) 55 to 95 weight percent, based on the total amount of the phenolic compound and the resorcinol mixture, of one or more phenolic compounds of formula (II);

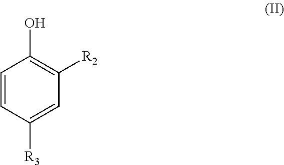

wherein R₂ and R₃ may be the same or different and each independently of each other selected from the group consisting of hydrogen, linear or branched (C₁-C₁₈)alkyl, and (C₆-C₁₀)aryl(C₁-C₄)alkyl;
c) cashew nut shell liquid comprising one or more compounds of formula (IV):

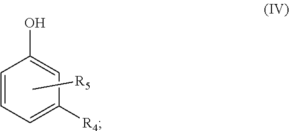

wherein R₄ is selected from the group consisting of n-C₁₅H₃₁alkyl, n-C₁₅H₂₉alkene, n-C₁₅H₂₇dialkene and n-C₁₅H₂₅trialkene; and R₅ is hydrogen, methyl or CO₂H; and
d) an aldehyde of formula (III):

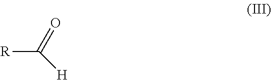

wherein R is selected from the group consisting of hydrogen and linear or branched (C₁-C₄)alkyl.

Accordingly, the resorcinol resin of this invention may contain various structural repeat units derived from the condensation product of respective resorcinol of formula (I), phenol of formula (II) and CNSL compound of formula (IV). Accordingly, the repeat units derived from the condensation product of resorcinol of formula (I) and an aldehyde of formula (III) may be represented by any one of formulae (VA), (VB) or (VC), where each denotation of [symbol] means a bond with any of the other repeat unit as described herein including a terminal group such as hydrogen:

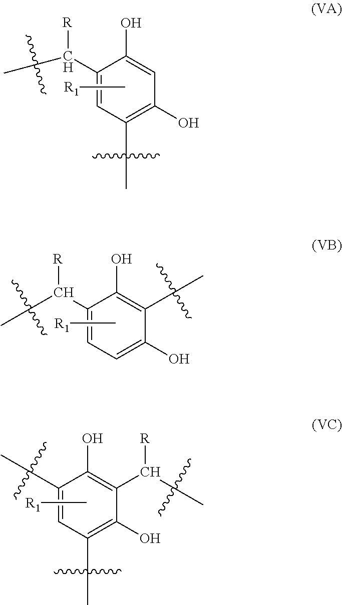

Similarly, the condensation product derived from the reaction of phenol of formula (II) with an aldehyde of formula (III) may be represented by repeat units of formulae (VD), (VE) or (VF):

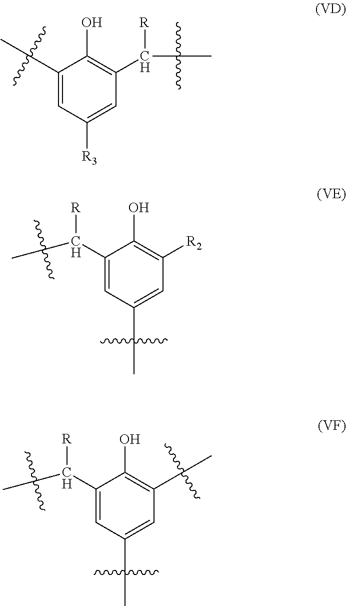

The condensation product derived from the reaction of CNSL compound of formula (IV) with an aldehyde of formula (III) may be represented by the repeat units of formulae (VG), (VH) or (VI):

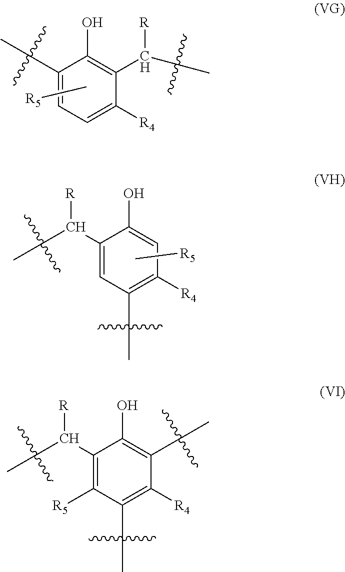

However, it should be noted that the above representations of repeat units of the resorcinol resin of this invention is for illustrative purpose only. Any of the other possible combinations of repeat units formed by the condensation product of phenolic compounds of formulae (I) and (II) and the CNSL compound of formula (IV) with aldehyde of formula (III) are also part of this invention. Accordingly, in some embodiments the resorcinol resin of this invention encompasses all of repeat units of formulae (VA) to (VI). In some other embodiments the resorcinol resin of this invention encompasses one or more of repeat units of formulae (VA) to (VC), one or more of repeat units of formulae (VD) to (VF) and one or more of repeat units of formula (VG) to (VI). In some embodiments the resorcinol resin of this invention contains any other possible repeat units that can be formed by the condensation product of phenolic compounds of formula (I) or (II) or CNSL compound of formula (IV) with aldehyde of formula (III) in addition to the foregoing repeat units of formulae (VA) to (VI).

As noted, the resorcinol resin of this invention contains very low levels of monomers from which it is formed. That is, the resorcinol resin of this invention contains very low levels of free resorcinol compound mixture of formula (I) as well as very low levels of free phenolic compounds of formula (II). Accordingly, in some embodiments, the resorcinol resin in accordance of this invention contains less than 0.5 weight percent of each individual unreacted resorcinol of formula (I), based on the total weight of resorcinol resin. In some other embodiments, the resorcinol resin of this invention contains less than 0.1 weight percent of each individual unreacted resorcinol of formula (I), based on the total weight of resorcinol resin. In yet some other embodiments, the resorcinol resin in accordance of this invention contains less than 0.5 weight percent of each individual unreacted resorcinol of formula (I); contains less than 1 weight percent of each individual unreacted phenolic compound of formula (II); and contains less than 1 weight percent of unreacted cashew nut shell liquid, based on the total amount of resorcinol resin.

In yet some other embodiments, the resorcinol resin in accordance of this invention contains less than 0.25 weight percent of each individual unreacted resorcinol of formula (I); contains less than 0.5 weight percent of each individual unreacted phenolic compound of formula (II); and contains less than 0.5 weight percent of unreacted cashew nut shell liquid, based on the total amount of resorcinol resin. In yet some other embodiments, the resorcinol resin in accordance of this invention contains less than 2 weight percent of total unreacted monomers, including unreacted resorcinol of formula (I); unreacted phenolic compound of formula (II); and unreacted cashew nut shell liquid, based on the total amount of resorcinol resin.

Advantageously, as further illustrated by specific examples herein, the resins of this invention exhibit various superior properties including but not limited to shorter reaction time in preparing various rubber formulations, improved reinforcing properties, tackifying properties, improved adhesion properties, ultra low levels of monomer content, among other improved properties as described hereinabove and hereafter.

In further embodiments of this invention there is provided use of the novolac resorcinol resin produced in accordance with the process of this invention in rubber applications, such as for example, as reinforcing resins or as adhesion promoters or as tackifying resin in rubber applications.

In one embodiment there is provided use of novolac resorcinol resin according to this invention as adhesion promoting resin for rubber tyres.

In one embodiment there is provided the use of novolac resorcinol resin according to this invention as tackifying resin for the confection of rubber tyres in the automotive sector.

In one embodiment there is provided a rubber formulation containing a natural rubber, a synthetic rubber, or a mixture of the two, and the novolac resorcinol resin according to this invention.

In one embodiment there is provided a rubber formulation according to this invention, wherein the novolac resorcinol resin according to this invention is present in a ratio of 1 to 7 parts by weight per 100 parts by weight of rubber.

In one embodiment there is provided a rubber tyre containing a novolac alkylphenol resin according to this invention.

The following Examples illustrate the process of making the resorcinol resins of this invention.

### Example 1

Cashew nut shell liquid (304.5 g), phenol (609 g), water (24.3 g) and oxalic acid (27.8 g) were charged in a 5 L three neck flask. The mixture was heated to 90° C., followed by drop-wise addition of an aqueous formaldehyde solution (50 wt %, 368.4 g) over 30 minutes. The mixture was refluxed for 2.5 hours, followed by addition of phenol (1151 g) and resorcinol (249.7 g). Next, an aqueous formaldehyde solution (50 wt %, 465.9 g) was added drop-wise over 40 minutes during which the reaction mixture was kept at reflux. After an additional 30 minutes of reflux, atmospheric distillation up to 140° C. was performed to remove the reaction water. This was followed by addition of triethanolamine (6 g). After stirring the mixture for an additional 15 min., vacuum distillation was carried out up to 30 mbar at 180° C. The resulting red-brown resin was poured in a metal pan and allowed to cool to room temperature. The test results of the resin are shown in Table 1.

### Example 2

Cashew nut shell liquid (207.6 g), phenol (1200 g), water (16.8 g), resorcinol (170.3 g) and sulfuric acid (37.6 weight percent, 23.8 g) were charged in a 3 L three neck flask. The mixture was heated to 90° C., followed by drop-wise addition of a formaldehyde solution (50 wt %, 568.1 g) over 1 hour. During this time, the reaction mixture was refluxed. After addition of the formaldehyde solution, the mixture was refluxed for an additional 45 min. Next, the water was distilled up to 110° C., followed by vacuum distillation up to 200 mbar at 110° C. The mixture was kept for 2 hours at 200 mbar and 110° C., followed by the addition of triethanolamine (14.4 g). Following, the temperature was gradually increased to 185° C. and the pressure was gradually decreased to 30 mbar to remove the excess phenol. The resulting red-brown resin was poured in a metal pan allowed to cool to room temperature. The resin test results are summarized in Table

TABLE 1

| Test method | Example 1 | Example 2 |
|---|---|---|
| Softening point, ° C. | 116 | 107 |
| Free phenol, wt % | 0.36 | 0.55 |
| Free resorcinol, wt % | 0.02 | 0.14 |
| Free CNSL, wt % | 0.09 | 0.57 |
| Softening point increase at 180° C., | 0.75 | 0.08 |
| ° C./h | | |

### Example 3

Example 1 was substantially repeated in this Example 3, however, the resorcinol resin according to the current invention was prepared in a pilot quantity for use in the rubber applications as described further hereinbelow.

### Test Methods

### Determination of Free Phenol Content

The quantity of free phenol in the resins was determined by gas chromatography, using a Shimadzu GC-2014 platform with an injector, a Phenomenex Zebron SE 30 packed column, a Flame Ionization Detector and software for recording and integration of the chromatogram. The samples were prepared in the following manner: 5 g of resin and 0.5 g of mono-chlorobenzene—used as an internal standard—were weighed into a 125 ml beaker and 100 ml of acetone was added. The response coefficient was determined by analysing phenol/mono-chlorobenzene standards under the same conditions.

### Determination of the Free Resorcinol Content

The quantity of free resorcinol in the resins was determined by gas chromatography, using a Shimadzu GC-2014 platform with an injector, a Phenomenex Zebron SE 30 packed column, a Flame Ionization Detector and software for recording and integration of the chromatogram. To improve the signal to noise ratio and peak sharpness, resorcinol was derivatized with N,O-bis(trimethylsilyl)trifluoroacetamide (BSTFA). The samples were prepared in the following manner: 0.75 g resin, 5 g tetrahydrofuran (THF) and 2.2 g BSTFA were weighed in septum vial. The closed vial was placed for 60 min. at 60° C., after which 0.03 g water and 0.06 g mono-chlorobenzene—used as internal standard—were added. The response coefficient was determined by analyzing derivatized resorcinol/mono-chlorobenzene standards under the same conditions.

### Determination of the Free CNSL Content

The content of free CNSL in the resins was determined by GC-MS at an independent research institute (Lab for applied and analytical chemistry at the University of Hasselt). For an accurate determination, the CNSL components were derivatized with BSTFA.

### Determination of the Softening Point

The softening points were determined according to the standard procedure with Ring & Ball, as described in ISO 4625-1:2004.

### Comparative Example 1

For comparative purposes a conventional resorcinol formaldehyde resin was used as Comparative Example 1.

### Comparative Example 2

For comparative purposes a conventional resorcinol, styrene formaldehyde resin, commercially available as Penacolite B-16-S Resin was used as Comparative Example 2.

### Comparative Example 3

For comparative purposes a conventional resorcinol, styrene formaldehyde resin, commercially available as Penacolite B-20-S Resin was used as Comparative Example 3.

The comparative properties of the resorcinol resin of this invention compared with Comparative Example 1 and Comparative Example 2 are summarized in Table 2.

TABLE 2

| | | Comparative | Comparative |
|---|---|---|---|
| Test Method | Example 1 | Example 1 | Example 2 |
| Softening Point, ° C. | 116 | 108 | 105 |
| Moisture, % | 0.4 | 0.5 | 0.5 |
| pH | 5.7 | 5 | 5 |
| Free resorcinol, wt % | 0.02 | 16 | 10 |

### Example 4—Comparative Examples 4-6

### Rubber Application Studies

The characteristics of a rubber formulation that contains a novolac resorcinol resin prepared according to the current invention (Example 4) were tested and compared with the characteristics of a rubber formulation that includes a conventional resorcinol resin as described in Comparative Example 1 (Comparative Example 4) and with the characteristics of a rubber formulation that includes two different grades of resorcinol, styrene and formaldehyde resin as described in Comparative Examples 2 and 3 (Comparative Examples 5 and 6). The novolac resorcinol resin used in Example 4 was prepared substantially in accordance with the procedure as set forth in Example 2.

For the tests, use was made of a rubber formulation that is typical for the tread of a vehicle tyre and is based on the patent EP0501227 B1. This rubber formulation was prepared in accordance with the procedures as set forth in ASTM D3182-16 using the following ingredients expressed as phr—parts per hundred parts resin:

100 phr—CV60 natural rubber
50 phr—N326 carbon black
10 phr HiSil 243 silica
5 phr—naphthenic oil
5 phr—zinc oxide
1 phr—stearic acid
3 phr—resorcinol resin of the current invention or the conventional resin as noted above
2 phr—6PPD, antidegradant
1 phr—TMQ, antidegradant

In a typical mixing example, the basic mixture was blended in a Banbury mixer and the speed of the rotors and the start temperature are adjusted in such a manner that the temperature at the end of the mixing cycle generally below 160° C. as summarized in Table 3. A mixing cycle generally starts at 100° C., and typically continues for about 4 to 6 minutes, see Table 3. In a first phase, the rubber was kneaded, and thereafter the silica, the aromatic oil, the silane and the respective resorcinol resin were added. Thereafter, rest of the ingredients were added to the mixture and the mixture was kneaded for 1 minute. The rubber formulations thus formed in the first pass were then subjected to similar mixing/kneading conditions in the second pass albeit at shorter mixing time and at lower dump temperature as summarized in Table 3. Thereafter, the rubber mixture is taken from the Banbury mixer and immediately calendered on rolls of 20° C. The resulting rubber formulations were analyzed for their properties and are summarized below.

TABLE 3

| | | Comparative | Comparative | Comparative |
|---|---|---|---|---|
| | Example 4 | Example 4 | Example 5 | Example 6 |
| First pass | | | | |
| Mixing time, min. | 3.9 | 5.0 | 5.9 | 4.7 |
| Total integrated | 50.2 | 70.5 | 99.1 | 65.5 |
| kWh | | | | |
| Dump | 157 | 157 | 156 | 157 |
| temperature, ° C. | | | | |
| Second pass | | | | |
| Mixing time, min. | 1.4 | 2.1 | 2.2 | 1.4 |
| Total integrated | 22.1 | 29.6 | 32.5 | 19.5 |
| kWh | | | | |
| Dump | 104 | 104 | 104 | 104 |
| temperature, ° C. | | | | |

It is evident from the data presented in Table 3, the rubber formulation prepared in accordance with this invention needs shorter mixing time of only 3.9 minutes, whereas the Comparative Examples required longer mixing times ranging from 4.7 minutes to 5.9 minutes.

The materials were tested for their rheological properties using MDR rheometer in accordance with ASTM S5289-12 procedures and the results are summarized in Table 4.

TABLE 4

| | Exam- | Comparative | Comparative | Comparative |
|---|---|---|---|---|
| Test Condition | ple 4 | Example 4 | Example 5 | Example 6 |
| Maximum Torque, | 2.00 | 1.95 | 1.92 | 1.93 |
| M_{H}, N-m | | | | |
| Minimum Torque, | 0.35 | 0.33 | 0.38 | 0.38 |
| M_{L}, N-m | | | | |
| Cure Time, t₅₀, | 14.1 | 7.8 | 9.7 | 12.8 |
| minutes | | | | |
| Cure Time, t₉₀, | 32.4 | 17.6 | 19.3 | 27.8 |
| minutes | | | | |
| Scorch Time, Tₛ2, | 6.33 | 3.85 | 4.58 | 5.98 |
| minutes | | | | |

The Mooney viscosity of the rubber formulated materials were measured in accordance with ASTM D1646-15 using Monsanto MV 2000 Viscometer at 100° C. using large rotor. The results are summarized in Table 5.

TABLE 5

| | Exam- | Comparative | Comparative | Comparative |
|---|---|---|---|---|
| Test Condition | ple 4 | Example 4 | Example 5 | Example 6 |
| MI, Initial Viscosity | 88.6 | 80.9 | 84.4 | 93.2 |
| (MU) | | | | |
| ML, Minimum | 74.1 | 67.7 | 68.7 | 71.1 |
| Viscosity (MU) | | | | |
| Mooney Viscosity, | 74.2 | 67.7 | 68.9 | 75.6 |
| ML 1 + 4 (MU) | | | | |

The adhesion between steel tire cords and rubber of the formulated materials were also tested in accordance with ASTM D2229-10(2014). The specimens were tested at 5.08 cm/min and the specimens were pulled from a ½″ block of rubber. For each formulation fifteen specimens were tested. The testing was also carried out for unaged samples and aged samples which were aged at 80° C. with 95% relative humidity for 21 days. The median, average and standard deviation of these fifteen specimens under each of these test conditions are summarized in Tables 6 and 7 respectively.

TABLE 6

| Test Condition - | Exam- | Comparative | Comparative | Comparative |
|---|---|---|---|---|
| Unaged specimens | ple 4 | Example 4 | Example 5 | Example 6 |
| Median | 51.9 | 48.15 | 48.71 | 50.21 |
| Average | 51.81 | 48.04 | 49.01 | 49.43 |
| Standard Deviation | 2.61 | 3.25 | 2.64 | 3.63 |

TABLE 7

| Test Condition - aged | | | | |
|---|---|---|---|---|
| specimens, 21 days at | | | Compar- | Compar- |
| 80° C. with 95% | | Comparative | ative | ative |
| relative humidity | Example 4 | Example 4 | Example 5 | Example 6 |
| Median | 39.9 | 37.69 | 40.58 | 41.65 |
| Average | 39.98 | 38.01 | 39.19 | 41.21 |
| Standard Deviation | 2.4 | 2.04 | 5.74 | 2.04 |

Although the invention has been illustrated by certain of the preceding examples, it is not to be construed as being limited thereby; but rather, the invention encompasses the generic area as hereinbefore disclosed. Various modifications and embodiments can be made without departing from the spirit and scope thereof.

What is claimed is:

1. A process for the preparation of resorcinol resins, comprising:
(a) providing 4 to 45 weight percent, based on the total amount of a phenolic compound and a resorcinol compound mixture, of resorcinol compound of formula (I): 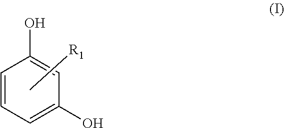
wherein R₁ is selected from the group consisting of hydrogen, linear or branched (C₁-C₁₈)alkyl and (C₆-C₁₀)aryl(C₁-C₄)alkyl, and providing 55 to 95 weight percent, based on the total amount of phenol and resorcinol mixture, one or more of phenolic compound of formula (II); 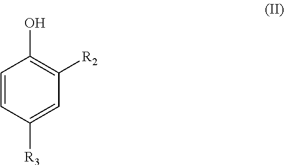
wherein R₂ and R₃ may be the same or different and each independently of each other selected from the group consisting of hydrogen, linear or branched (C₁-C₁₈)alkyl, and (C₆-C₁₀)aryl(C₁-C₄)alkyl;
(b) providing cashew nut shell liquid comprising one or more compounds of formula (IV): 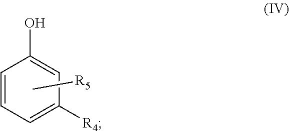
wherein R₄ is selected from the group consisting of n-C₁₅H₃₁alkyl, n-C₁₅H₂₉alkene, n-C₁₅H₂₇dialkene and n-C₁₅H₂₇trialkene; and R₅ is hydrogen, methyl or CO₂H;
(c) adding an acid; and
(d) adding an aldehyde of formula (III): 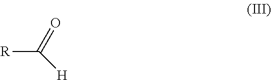
wherein R is selected from the group consisting of hydrogen and linear or branched (C₁-C₄)alkyl.

2. The process according to claim 1, wherein the obtained resorcinol resin contains less than 0.5 weight percent of each individual unreacted resorcinol of formula (I), based on the total weight of resorcinol resin.

3. The process according to claim 1, wherein the obtained resorcinol resin contains less than 0.5 weight percent of each individual unreacted resorcinol of formula (I); contains less than 1 weight percent of each individual unreacted phenolic compound of formula (II); and contains less than 1 weight percent of unreacted cashew nut shell liquid, based on the total amount of resorcinol resin.

4. The process according to claim 1, wherein the obtained resorcinol resin contains less than 2 weight percent of total unreacted monomers, including unreacted resorcinol of formula (I); unreacted phenolic compound of formula (II); and unreacted cashew nut shell liquid, based on the total amount of resorcinol resin.

5. The process according to claim 1, wherein the molar ratio of the aldehyde of formula (III) to the total amount of the chemical substances of formula (I) and (II) is less than 1.

6. The process according to claim 1, wherein the resorcinol compound of formula (I) is resorcinol.

7. The process according to claim 1, wherein the phenolic compound of formula (II) is selected from the group consisting of phenol, o-cresol, m-cresol, p-cresol, 2,3-xylenol, 2,4-xylenol, 2,5-xylenol, 2,6-xylenol, 3,4-xylenol and 3,5-xylenol, and mixtures in any combination thereof.

8. The process according to claim 1, wherein the aldehyde of formula (III) is selected from the group consisting of formaldehyde, acetaldehyde, propionaldehyde, n-butyraldehyde, iso-butyraldehyde, glyoxal and furfural.

9. The process according to claim 1, wherein the resorcinol compound of formula (I) is resorcinol, phenolic compound of formula (II) is phenol and the aldehyde of formula (III) is formaldehyde.

10. The process according to claim 1, wherein the acid is selected from the group consisting of sulfuric acid, sulfonic acids, and carboxylic acids, e.g., sulfuric acid, p-toluene sulfonic acid, methane sulfonic acid, dodecylbenzene sulfonic acid, triflic acid, fluorosulfuric acid and oxalic acid.

11. The process according to claim 1, wherein the acid is oxalic acid and the aldehyde is formaldehyde, used as an aqueous solution thereof.

12. The process according to claim 1, wherein the aldehyde having the structural formula III is obtained by adding chemical substances that can decompose into similar aldehydes, the chemical substances that can decompose being selected from the group consisting of paraformaldehyde, paraldehyde, trioxane, furfural, hexamethylenetetramine, (3-hydroxybutyraldehyde, acetals such as methylformcel and butylformcel, and mixtures of at least 2 of the same.

13. The process according to claim 1, wherein water is removed at a reaction temperature below 125° C. or below 115° C. from the reaction mixture by vacuum distillation and wherein the reaction mixture is neutralized at a temperature below 125° C. or below 115° C.

14. The process according to claim 1, which is further comprising the following steps for processing the mixture after completion of a condensation reaction:
a step of distilling the mixture at atmospheric pressure until a temperature of about 120° C. to 145° C. is reached, without neutralizing the acid beforehand;
after that, a step of neutralizing the acid; and
after that, a step of carrying out a distillation under a reduced pressure of 100 mm Hg or less until a temperature of about 150° C. to 180° C. is reached.

15. A resorcinol resin obtained by the process according to claim 1, wherein the resorcinol resin exhibits a softening temperature of from 80 to 130° C., and contains less than 0.5 weight percent and preferably less than 0.1 weight percent of each resorcinol and less than 0.5 weight percent phenol and less than 0.5 weight percent cashew nut shell liquid, based on the total amount of novolac resorcinol resin.

16. A resorcinol resin obtained by the process according to claim 1, wherein the cashew nut shell liquid is cardanol.

17. A resorcinol resin, comprising:
a) 5 to 45 weight percent, based on the total amount of a phenolic compound and a resorcinol compound mixture, of repeat units of formula (VA), (VB) or (VC) derived from resorcinol compound mixture of formula (I) and an aldehyde of formula (III): 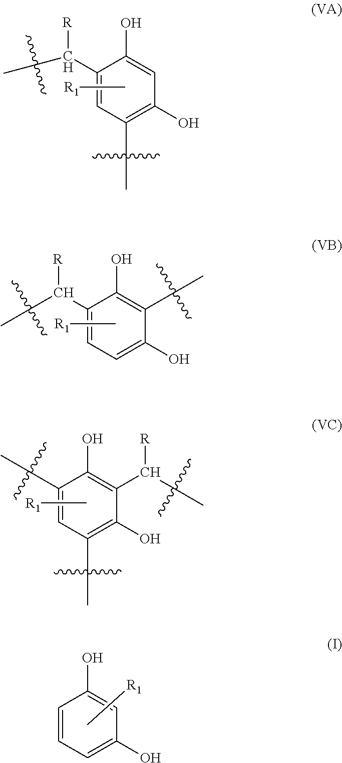
wherein [symbol]
represents a position at which the bonding takes place with another repeat unit;
R₁ is selected from the group consisting of hydrogen, linear or branched (C₁-C₁₈)alkyl, and (C₆-C₁₀)aryl(C₁-C₄)alkyl;
b) 55 to 95 weight percent, based on the total amount of the phenolic compound and the resorcinol mixture, of repeat units of formula (VD), (VE) or (VF) derived from one or more phenolic compounds of formula (II) and an aldehyde of formula (III); 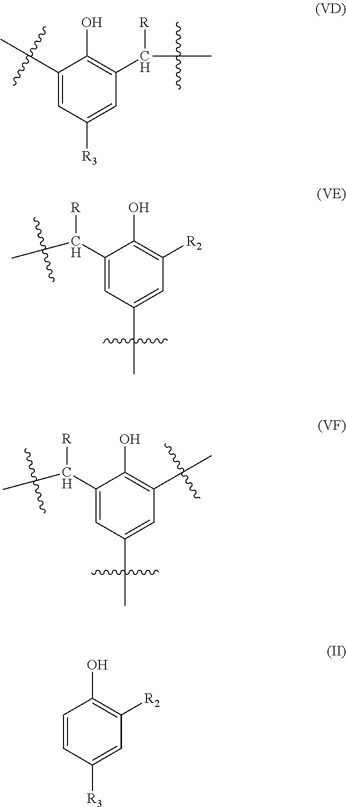
wherein [symbol]
represents a position at which the bonding takes place with another repeat unit;
R₂ and R₃ may be the same or different and each independently of each other selected from the group consisting of hydrogen, linear or branched (C₁-C₁₈)alkyl, and (C₆-C₁₀)aryl(C₁-C₄)alkyl; and
c) repeat units of formula (VG), (VH) or (VI) derived from cashew nut shell liquid comprising one or more compounds of formula (IV) and an aldehyde of formula (III): 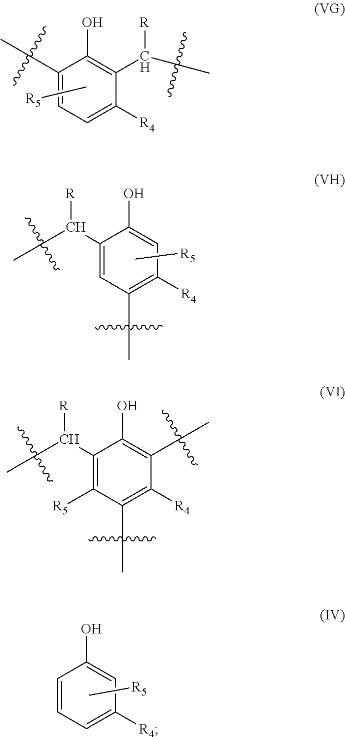
wherein [symbol]
represents a position at which the bonding takes place with another repeat unit;
R₄ is selected from the group consisting of n-C₁₅H₃₁alkyl, n-C₁₅H₂₉alkene, n-C₁₅H₂₇dialkene and n-C₁₅H₂₇trialkene; and R₅ is hydrogen, methyl or CO₂H; and
where an aldehyde of formula (III) is: 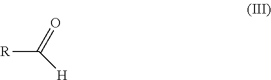
wherein R is selected from the group consisting of hydrogen and linear or branched (C₁-C₄)alkyl; and
wherein the resorcinol resin contains less than 0.5 weight percent of free resorcinol of formula (I) based on the total amount of resorcinol resin and exhibits softening point higher than 105° C.

18. A rubber formulation comprising the resorcinol resin according to claim 17, which exhibits improved reinforcing, tackifying and adhesion properties.

19. A rubber formulation containing a natural rubber, a synthetic rubber, or a mixture of the two, and the resorcinol resin according to claim 17.

20. A rubber tyre containing a resorcinol resin according to claim 17.
